(19) United States
(12) Patent Application Publication
(10) Pub. No.: US 2012/0269942 A1
(43) Pub. Date: Oct. 25, 2012

(54) TREATMENT SOLUTION FOR SLICED FRUIT

(76) Inventor: Ihab Hekal, Miami, FL (US)

(21) Appl. No.: 13/453,003

(22) Filed: Apr. 23, 2012

Related U.S. Application Data
(60) Provisional application No. 61/457,585, filed on Apr. 25, 2011.

(51) Int. Cl. A23B 7/10

(52) U.S. Cl. 426/335

(57) ABSTRACT

A treatment for peeled or sliced produce, particularly sliced apples, comprises the steps of placing the sliced produce in a preferred solution for approximately 20 seconds and storing the treated produce at approximately 40 degrees F. One chemical composition for the treatment of peeled or sliced produce, particularly sliced apples, is a treatment solution composed of water plus the following chemicals by weight %:

| | |
|---|---|
| Lactic Acid | 0.51% |
| Ca-Lactate | 0.34% |
| CaCl₂ | 1.13% |
| CaCO₃ | 1.07% |
| Ascorbic Acid | 3.95% |
| Total | 7.00% |

### BACKGROUND OF THE INVENTION

Numerous patents teach the use of ascorbic acid and calcium and/or magnesium salts for the preservation of produce, including peeled or sliced fruits and vegetables. My earlier patent, U.S. Pat. No. 7,851,002, granted on Dec. 14, 2010, is an example. Typically, the prior art specifies that the ascorbic acid concentration should be twice the concentration of the calcium ions concentration such that the ratio of ascorbic acid to calcium ions is about 2:1. My earlier patent disclosed a treatment using a solution having a pH between pH 6.5 and pH 7.0 (low acid food). It is recognized that there is a danger of having a food treatment solution at a pH above pH 5 (a definition for low acid food), because of the possibility of growing bacteria such as E. coli, listeria and salmonella, which would present a public health hazard. Also it could be a reason for ending the commercialization of fresh, sliced and peeled vegetables and fruit, particularly peeled and sliced apples. Typically, commercial apple treatment solutions currently have a pH of around 7.0.

Producers of sliced apples have indicated to me that their major problem is their need to prevent bacteria contamination such as E. coli, listeria, or salmonella. This could be a devastating blow to the fresh, sliced apple industry.

### SUMMARY OF THE INVENTION

A low pH, i.e., below 5.0, (a definition of high acid food) is one way to prevent the growth of these bacteria; however, merely using a low pH solution would cause fresh, sliced and peeled apple to lose the fresh apple texture and make the surface soft and gelatinous and cause the sliced apple to shrivel and wilt. I found a condition (soft in which I lowered the pH of the solution to a pH below 5 and increased the calcium ions concentration so that the ratio of ascorbic acid to calcium ions is about 1:1 or above. I developed a chemical treatment compound, to make a solution for the treatment of fresh, peeled and/or sliced apple, that would provide a high acid solution of a pH 4.8 and below, so that the treatment bath would not be a breeding ground for dangerous bacteria.

It is known that high acid liquid does not support the growth of pathogenic bacteria such as E. coli, listeria, and salmonella. Ascorbic acid is well known to prevent the apple from discoloration, i.e., turning brown, but the texture of the apple deteriorates rapidly. However, using calcium ascorbate will keep the apple slices like fresh, with good texture, and without discoloration; however that solution has a pH of 6.7 and therefore will support the growth of pathogenic bacteria such as E. coli, listeria, and salmonella.

### DESCRIPTION OF THE PREFERRED EMBODIMENT(S)

I have tried many combinations and many experiments, and I have found a concentration that would provide a treatment solution that keeps the peeled or sliced apple from discoloration and also keeps the texture like fresh, and prevents the apple from softening and turning brown.

My invention solves the problem. Since high acid solutions do not support the growth of pathogenic bacteria such as E. coli, listeria and salmonella, I worked to find a solution in which I can increase the level of calcium ions ratio to ascorbate ions, keep the solution pH below pH 5, and thereby obtain apple slices that retain the texture of fresh sliced apple, and do not discolor.

After many hundreds of experiments, most of which failed, because of one reason or another, I was finally able to make an improved solution composition. My invention comprises the steps of dipping apple slices in the solution for 20 seconds at 40 degrees F., and separating the slices from the solution. I then stored the treated slices in a plastic “egg shell” polyethylene container for four (4) weeks, during which time I examined the apple slices every week for color, texture, and taste. After 4 weeks of comparing different solutions, I selected successful compositions for further testing.

Of the selected compositions, I then tested them using larger quantities of apples, and selected the top two favorable compositions. Again I made micro changes in the composition to keep the pH below pH 5 and finally I reached a preferred composition. During my experiments, I have displayed the treated apple slices to about 30 individuals and asked them to judge between the treated slices and the untreated sliced fresh apple. I used a triangular test in which I had two bowls of fresh apples and one bowl of treated apples, and four of five observers preferred the sliced apples that were treated with my treatment solution.

As a result of my extensive testing, my two preferred chemical composition of the apple treatment solution are composed of tap water, or filtered well water, and the following weight %:

### Composition 1:

| | |
|---|---|
| Lactic Acid | 0.51% |
| Ca-Lactate | 0.34% |
| CaCl₂ | 1.13% |
| CaCO₃ | 1.07% |
| Ascorbic Acid | 3.95% |
| | 7.00% |

### Composition 2:

| | |
|---|---|
| Malic/Citric Acid | 0.40% |
| CaCl₂ | 1.30$ |
| CaCO₃ | 1.20% |
| Ascorbic Acid | 4.10% |
| | 7.00% |

It is noted in Composition 1 that the (Molar Ratio) the Calcium ions: Ascorbate Ions ratio is more than 1.0.

Molar concentration of Ascorbate ions=39.5 g/l/176=0.224 Molar solution of Ascorbate Ions

Molar concentration of Calcium Ions in Calcium Lactate=3.4 g/l/218=0.016 Molar solution of Calcium Ion

Molar concentration of Calcium Ions in Calcium Chloride=11.30 g/l/111=0.102 Molar solution of Calcium Ion

Molar concentration of Calcium Ions in Calcium Carbonate=10.70 g/l/100=0.107 Molar solution of Calcium Ion

Total Calcium Ions concentration=0.016+0.102+0.107=0.0.225

Thus, the Molar Ratio of Calcium Ion/Ascorbate Ions is more than 1.

It is noted in Composition 2 that the (Molar Ratio) the Calcium ions: Ascorbate Ions ratio is more than 1.0.

Molar concentration of Ascorbate ions=41.0 g/l/176=0.233 Molar solution of Ascorbate Ions

Molar concentration of Calcium Ions in Calcium Chloride=13.00 g/l/111=0.117 Molar solution of Calcium Ion

Molar concentration of Calcium Ions in Calcium Carbonate=12.00 g/l/100=0.120 Molar solution of Calcium Ion

Total Calcium Ions concentration=0.117+0.120=0.0.237

Thus, the Molar Ratio of Calcium Ion/Ascorbate Ions is more than 1.

Further, I studied patents belonging to a leader in the field and my tests showed that the pH of their products were usually in the range of a pH in the range of 6.7 to 7.0., This is not a high acid media. I experimented by lowering the pH to approximately 3.0 and tested the treated product; after storing the treated product in a refrigerator, at 2-4 degrees C., the final product was a disaster.

I continued working on modifying the ratio of ascorbic acid and calcium ions, and finding a preferred pH. Eventually, I concluded that: (1) the pH should not be below 4.0 but should be in the range of 4.0 to 5.0, (2) preferably 4.5 TO 5.0, and (3) an optimum of 4.5 TO 4.8. Further, the ascorbic acid to calcium ratio should be less than 2:1, preferably 2.5 to 2, i.e., nearly 1 to 1. Also, I use acids such as lactic, formic, malic and citric, or a combination of malic/citric acids to adjust the pH of the solution. Calcium chloride and calcium carbonate can also be used to control the pH while maintaining the calcium ions concentration.

A preferred process for treating peeled or sliced produce, particularly sliced apples, comprises the steps of placing the sliced produce in the above described solution for approximately 20 seconds, removing the produce from the solution, and storing the treated produce at approximately 40 degrees F.

I claim:

1. A process for preserving fresh sliced produce, said process comprising the steps of treating said produce with an aqueous solution consisting essentially of water, ascorbic acid and calcium ions by immersing the sliced produce in said solution for approximately 20 seconds, removing the produce from the solution, and storing the treated produce at approximately 40 degrees F.

2. The process of claim 1 wherein said solution contains a molar ratio of calcium ions to a molar ratio of ascorbate ions in a ratio that is more than 1.0.

3. The process of claim 1 wherein the pH of said solution is in the range of 4.0 to 5.0.

4. The process of claim 3 wherein the pH of said solution is in the range of 4.5 to 4.8.

5. The process of claim 4 wherein the pH of said solution is controlled with acids selected from the group consisting of lactic, formic, malic and citric acids.

6. The process of claim 4 wherein the pH of said solution is controlled with calcium chloride.

7. The process of claim 4 wherein the pH of said solution is controlled with calcium carbonate.

8. The process of claim 4 wherein said solution contains a molar ratio of calcium ions to a molar ratio of ascorbate ions in a ratio that is more than 1.0.

9. The process of claim 5 wherein said solution contains a molar ratio of calcium ions to a molar ratio of ascorbate ions in a ratio that is more than 1.0.

10. The process of claim 9 wherein said sliced produce is sliced apples.

11. The process of claim 1 wherein said sliced produce is sliced apples.
